(19) United States
(12) Patent Application Publication
(10) Pub. No.: US 2012/0143650 A1
(43) Pub. Date: Jun. 7, 2012

(54) METHOD AND SYSTEM OF ASSESSING AND MANAGING RISK ASSOCIATED WITH COMPROMISED NETWORK ASSETS

(76) Inventors: Thomas CROWLEY, Atlanta, GA (US); Andrew HOBSON, Atlanta, GA (US); Stephen NEWMAN, Johns Creek, GA (US); Joseph WARD, Atlanta, GA (US)

(21) Appl. No.: 13/309,202

(22) Filed: Dec. 1, 2011

Related U.S. Application Data
(60) Provisional application No. 61/420,182, filed on Dec. 6, 2010.

(51) Int. Cl. G06F 21/20; G06Q 10/00

(52) U.S. Cl. 705/7.28; 726/25

(57) ABSTRACT

A method of managing risk associated with at least one compromised network asset, comprising: performing processing associated with receiving evidence regarding the at least one compromised network asset; performing processing associated with assessing at least one risk associated with the at least one compromised network asset; and/or performing processing associated with prioritizing at least two compromised network assets in order to determine how to respond to the at least one risk.

### CROSS-REFERENCE TO RELATED APPLICATIONS

This application claims the benefit of U.S. Provisional Patent Application No. 61/420,182, filed Dec. 6, 2010, which is incorporated by reference in its entirety.

### BRIEF DESCRIPTION OF THE FIGURES

FIGS. 1 and 9 illustrate a method for assessing and managing risk, according to one embodiment.

FIGS. 2A-2C are system diagrams illustrating a network event, and detailing the distinction between data indicative of a malicious network event and the forensics collected during a malicious network event that indicates risk, according to one embodiment.

FIG. 3 is a flow diagram that illustrates a method of weighing a series of risk components to derive a composite risk score, according to one embodiment.

FIG. 4 is a flow diagram that illustrates both a method of correlating a risk score with specific event attributes and a method, of automating alerts, according to one embodiment.

FIG. 5 is a graphic of one embodiment of the invention illustrating a screen capture of information displayed to a user as it relates to specific details related to compromised assets found on a network.

FIGS. 6A-6D are a graphic of one embodiment of the invention illustrating a screen capture of information displayed to a user as it relates to all available information related to assets on a network.

FIG. 7 is a graphic of one embodiment of the invention illustrating a screen capture of a list displayed to a user as it relates to the top compromised assets found on a network, according to the risk factor found for those assets.

FIG. 8 is a graphic of one embodiment of the invention illustrating a screen capture of a cross-tabular chart displayed to a user when comparing an asset's total risk with a specific communication attribute associated with the asset(s).

### DETAILED DESCRIPTION OF EMBODIMENTS OF THE INVENTION

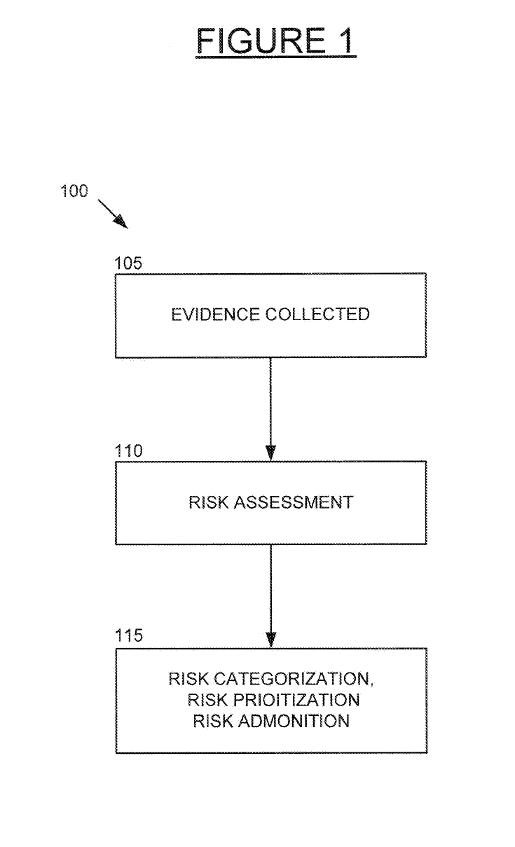

FIG. 1 is a diagram illustrating a method 100 of assessing and managing risk, according to one embodiment.

Some of the most severe malware acts involve asset access and control by remote criminal operators, who gain the ability to command and control malware-infected computer assets remotely by the organizational asset connecting to a remote server. In this manner, access to sensitive data can be gained and, in some cases, sent to individuals or organizations outside of the network. In addition, the organizational asset can be used, unknown to the organization, to carry out criminal acts.

Organizations seeking to detect and respond to such threats and/or many other types of threats, must track and assess, the risk to the organization of the infected assets, and thus the potential loss of information and/or other risks, on their network. FIG. 1 illustrates a method 100 of determining and managing risk associated with assets participating in malicious activity, according to one embodiment. Utilizing this method, in one embodiment, a rapid response to malicious activity can be instigated and thus the risk of data disclosure and/or loss (e.g., trade secrets, customer account information, credit card numbers, sales forecasts, etc.), as well as the use of these organizational assets in criminal acts can be mitigated using appropriate countermeasures.

It should be noted that a network event can be defined as communication from an organizational asset intended to establish a connection to a server outside of the organization. More specifically, in one embodiment, a malicious network event can be defined as a network event performed by malware on an organization's asset. Observing a “malicious network event” can indicate that the organizational asset is infected with malware. Those of ordinary skill in the art will see that there are many ways to discover and identify a “malicious network event”. In one embodiment of the invention, a method and system can: be provided to analyze attributes associated with or related to malicious network events from an organizational asset. In one embodiment, an attribute can be defined as forensic information collected during or related to the malicious network event. Attributes can be used to individually or collectively indicate a level of risk town organization that has assets taking part in malicious network events.

In order to derive the risk associated with an asset participating in malicious network events on a network, in 105, evidence used to derive risk can be collected. The evidence can include, but is not limited to, malware related attributes and forensics.

In 110, an assessment of risk can be performed. This assessment can be based on, for example, evidence collected in 105. The evidence can include attributes (e.g., forensics) associated with or related to malicious network events, gathered using, for example, files that depict the actual malicious network event and/or the description of the malicious network event. The evidence can also include attributes, for example: an asset's activity within the network and/or changes to assets and their associated network activity due to malware; and/or asset activity relative to other assets within the network. In one embodiment, an asset may posses a high relative risk due to current malicious network events. However, its derived relative risk may lessen upon the introduction of assets into the network with malicious network events associated with higher risk.

In 115, assessed risk can be categorized, prioritized, or admonitioned, or any combination thereof. The method and system 100 admonishes risk through the use of alerts sent to a user of the method and system, through mechanisms such as, and not limited to, graphical user interface presentation of risk, syslog alerts; e-mail, Simple Network Management Protocol (SNMP) traps and/or pager events, according to one embodiment.

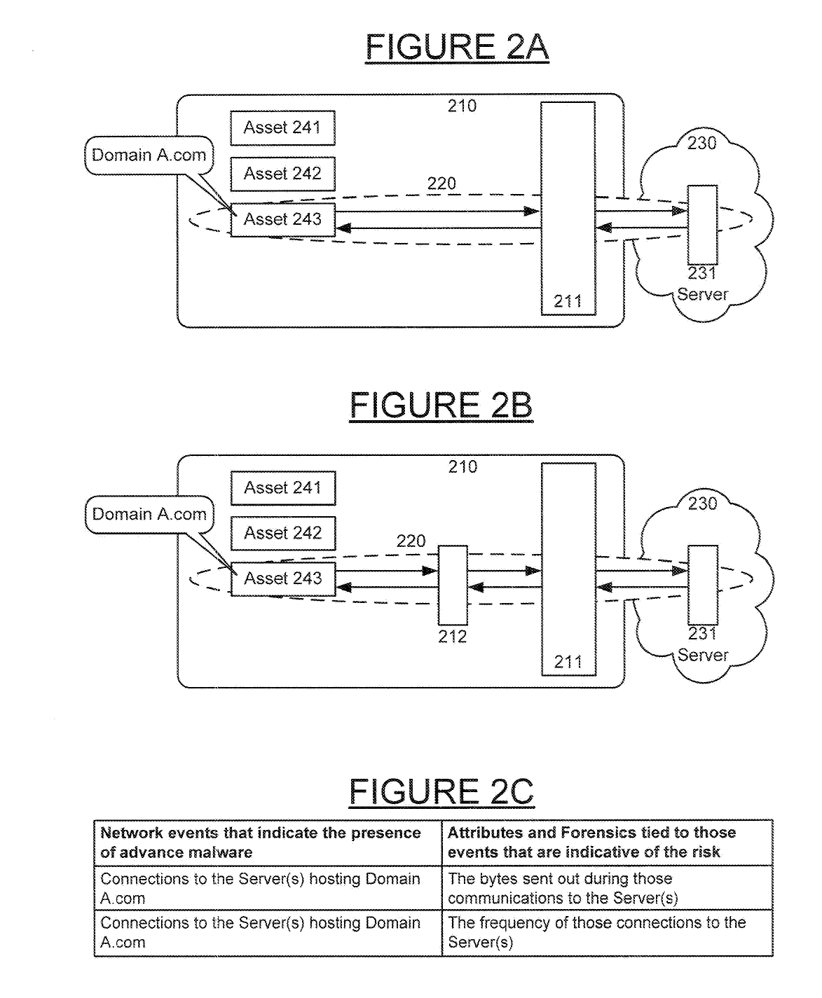

FIG. 2A is a system diagram illustrating a network event, and detailing the distinction between data indicative of a malicious network event and the forensics collected during a network event, according to one embodiment. FIG. 2A illustrates a network 210 with assets 241, 242 and 243. A type of two-way communication between asset 243 and a server 231 through a network egress/ingress point 211 (i.e. firewall), which can be called network event 220, is shown. The assets on network 210 (e.g., servers, laptops, workstations, etc.) may or may not contain malware. Asset 243 is shown in gray to indicate that it does contain malware. Assets 241 and 242 can exhibit network events like 220 to external servers like 231. In the case of asset 243, its network event 220 with server 231 contains event details commensurate with details associated with malware. The attributes pertaining to any asset's entire communication, as well as pieces of the asset's communication, can be analyzed, according to one embodiment. Although some aspects of communications between server 231 and compromised asset 243 may be identical to communications between server 231 and non-compromised assets 241 and 242 exhibiting similar network events to 220, the totality of the event details of the communication can still differ.

Referring again to FIG. 2A, the network event of communication between an asset and another entity may be indistinguishable for an asset containing malware and one that does not. However, the network event details of communication can contain information associated with malicious activity. For example, assets containing malware may attempt to connect to an external domain associated with some form of server previously associated with malicious activity (e.g., illustrated in this example as Domain A.com) hosted on server 231. The act of communicating to a known malicious domain, Domain A.com, is an event detail of the network event 220 that makes it a malicious network event and indicates the presence of malware on asset 243.

FIG. 2B depicts an alternate network configuration, where network event 220 is brokered by proxy server 212, according to one embodiment. Ingress/egress point (i.e., Firewall) 211 accepts outbound communication attempts by internal assets 241, 242, and 243 only when brokered by proxy server 212. Assets 241, 242, and 243 are configured to communicate through proxy server 212. The inclusion of proxy server 212, however, does not affect the malicious network events associated with malware presence on assets or their associated attributes; rather, it will affect the hardware placement and deployment. The network event pattern 220 can thus be extended to include, and not be confined by, communication to and from the proxy server 212 and assets 241, 242 and 243. Any external communications between asset 241, 242, and 243 and server 231 are brokered and not brokered by proxy server 212. The network events 220 with event details such as, but not limited to, known malicious domains, can be indicative of the presence of malware, but these events alone do not provide indication of risk. The attributes and forensics tied to these network events 220, when they are identified as malicious network events, are indicators of risk.

In the network configuration of FIG. 2B, attributes associated with the network event 220, which has been identified as a malicious network event, may comprise, but are not limited to: the number of communication attempts, the amount of data sent and/or received by the asset in question, the total number of known threats present on the asset, or the level of priority assigned to the asset on the network, or any combination thereof.

FIG. 2C illustrates two examples of attributes collected in some embodiments of the invention. The differentiation between a malicious network event and an attribute of a malicious network event is shown, according to one embodiment of the invention. For example, network events that can indicate the presence of malware are connections to the server(s) hosting Domain A.com; this indicates that these events are malicious network events. Attributes and forensics tied to those events that are indicative of the risk can include the bytes sent out during the communications to the server and/or the frequency of those connections to the server.

It should be noted that method 100 is not limited to calculating the risk based solely upon event attributes, but rather, may assess risk based upon any network activity associated with, but not confined to, an asset's communication with a server. In one embodiment, attributes collected as forensics can be used to calculate risk associated with internal assets.

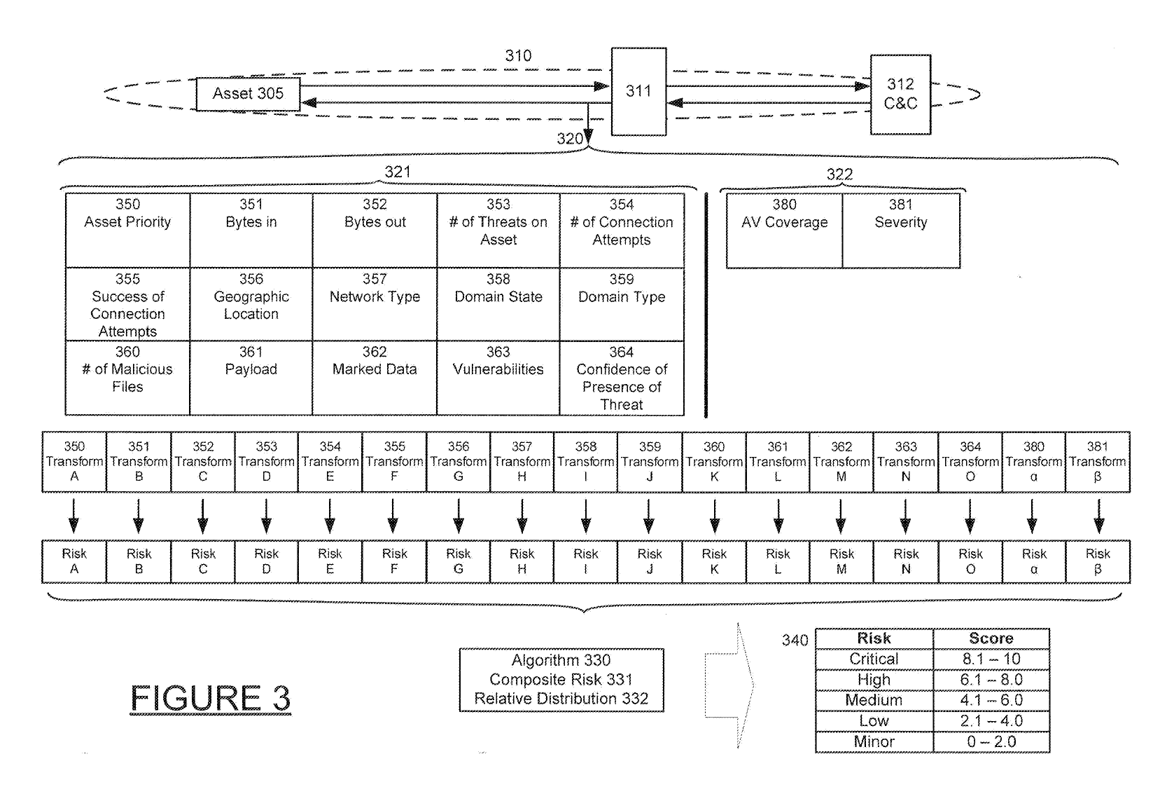

FIG. 3 illustrates an example derivation of risk 300, according to one embodiment. In this example, the network event between compromised internal asset 305 and server 312 can contain attributes 320. These attributes 320 can include, but are not limited to: local attributes 321 and/or global threat attributes 322. Local attributes 321 can be derived information descriptive of malicious activity occurring within a network. Global threat attributes 322 can be information derived externally to a network that is descriptive of a threat to that network.

As illustrated in FIG. 3, local attributes 321 can include, but are not limited to, the following:

Asset Priority 350. A configurable priority set to specific assets, indicating their importance to an organization, expressed as a number in the 0-100 range, according to one embodiment. As an example, an asset of priority 100 may represent a mission-critical asset.

Bytes In 351. The total quantity of information observed to enter the asset, once a successful connection is established, expressed as a number in the 0-100 range, according to one embodiment. As an example, an asset with Bytes In of 100 may represent but is not limited to a high amount of instruction sets, commands, or repurposed malware (newer malware) delivered to the infected asset by a remote criminal operator.

Bytes Out 352. The total quantity of information observed to exit the asset, once a successful connection is established, expressed as a number in the 0-100 range, according to one embodiment. As an example, an asset with Bytes Out of 100 may represent but is not limited to the exfiltration of data such as personal identification information, trade secrets, proprietary or confidential data, or intellectual property to remote criminal operators as a form of data theft.

Number of Threats on Asset 353. The number of unique instances of active threats on the asset, expressed as a number in the 0-100 range, according to one embodiment. As an example, an asset with a Number of Threats of 100 would represent an asset that has a large number of infections and therefore a higher risk.

Number of Connection Attempts 354. The total number of times a connection has been attempted to/from the asset, regardless of success, according to one embodiment. As an example, an asset with a Connection Attempts of 100 would represent an asset who has active, frequent communication with at least one criminal operator and is thus an active threat.

Success of Connection Attempts 355. The percentage of times the connection attempts successfully connect and exchange data as part of a malicious network event, expressed as a number in the 0-100 range, according to one embodiment. As an example, an asset with Successful Connection Attempts of 100 would represent an asset who has successfully communicated with a remote criminal operator and thus exchanged communications.

Geo-Location of Connection Attempts 356. A configurable priority set to the specific geo-location based on the location of the IP address of connection attempts related to malicious network events, expressed as a number in the 0-100 range, according to one embodiment. As an example, a geo-location priority 100 may represent a connection attempt to an IP address located in a country designated to be high risk by the customer.

Network Type for Connection Attempt 357. A configurable priority set to specific network types, such as residential, commercial, government or other networks, as being higher risk for connection attempts, related to malicious network events, expressed as a range 0-100 according to one embodiment. As an example, a network type of priority 100 may represent a network (e.g., residential) which customer data should not be connecting to.

Domain State: Active or Sinkholed 358. The identification of a domain as Active or Sinkholed related to a DNS query and/or subsequent connection attempt related to a malicious network event, expressed as a range of 0-100, according to one embodiment. As an example, a Domain. State of 100 may represent an Active domain where a Domain State of 50 may represent a Sinkholed domain.

Domain. Type: Paid or Free Dynamic DNS Domain 359. The identification of a domain as either a paid domain or a free dynamic DNS domain as part of a DNS query related to a malicious network event, expressed as a range of 0-100, according to one embodiment. As an example, a Domain Type of 100 may represent a free dynamic DNS domain where a Domain Type of 50 may represent a paid domain.

Number of Malicious Files 360. The total number of malicious files observed to go to an asset, expressed as a number in the 0-100 range, according to one embodiment. As an example, an asset with a Number of Malicious Files of 100 would represent an asset that is actively receiving new malware or repurposed malware to infect or re-infect the asset to either evade detection or to carry out new malicious events.

Payload 361. A priority (e.g., which may be configurable), set to the type of payload, such as but not limited to, obfuscated, encrypted, or plain text, observed during connection attempts related to malicious network events, expressed as a range 0-100, according to one embodiment. As an example, a Payload of 100 may represent an encrypted payload.

Marked Data 362. A configurable priority set for observed marked data, such as “Confidential” or “Proprietary”, observed during connection attempts related to malicious network events, expressed as a range 0-100 according to one embodiment. As an example, an asset with Marked Data of 100 would represent an asset that has been involved in exfiltration of confidential or proprietary data thus indicating data theft by a remote criminal operator.

Vulnerabilities 363. A configurable priority set to specific assets based on identified vulnerabilities on those assets, expressed as a range 0-100, according to one embodiment. As an example, a Vulnerability of 100 would indicate the asset being investigated has known vulnerabilities that could be used by the remote criminal operator to control the asset and exfiltrated data.

Confidence of Presence of Advanced Malware 364. A configurable priority set for specific assets based on the confidence the system has of the presence of advanced malware on the asset; expressed as a range 0-100, according to one embodiment. As an example, an asset with a Confidence of 100 would indicate a higher risk that data could be exfiltrated from a network.

It should be noted that the ranges described above are example ranges, and that many other ranges can be used.

It should also be noted that, in the local attribute list 321 in FIG. 3, asset priority 350 is highlighted with a gray box. This is to indicate as an example that, in one embodiment, asset priorities can be unique and can be defined as categories that are configurable by an end user, according to one embodiment. Similarly, any local attribute listed in 321 in FIG. 3 can be configurable by an end user. The categories can define an end user's assumed importance of an asset within a network. For example, users can categorize certain assets within their network as mission critical. Network events associated with mission critical assets can in this manner be emphasized over network events associated with assets that are not as heavily prioritized, according to one embodiment. Communication Attributes related to malicious network events associated with these mission critical assets can contribute to overall risk assessment in proportion to their category, with higher priority categories carrying more weight within the risk assessment. In this manner, categories can influence how asset risk can be weighed and how remediation efforts, can be prioritized. It should be noted that, in some embodiments, other attributes can be configurable by an end user.

FIG. 3 also lists global threat attributes 322, which can represent attributes based upon, and not confined by, previously observed/categorized malware types and events. Global threat attributes 322 can include, but are not limited to, the following:

AV Coverage 380. A percentage correlating the availability of an AV vendor's anti-virus/malware signature for specific known malware variants, according: to one embodiment. As an example, the AV Coverage of 0 would indicate the referenced AV vendor has no coverage for the threat and as such it poses greater risk to the user and that the AV vendor will have a poor chance of assisting in remediation efforts.

Severity 381. For known threats related to malicious communications, a ranking can be based upon previously observed exploits to internal networks, expressed as a number in the 0-100 range, according to one embodiment. As an example, an asset with a threat that has Severity of 100 represents a high risk to the network based on prior experience about the threat in other networks.

It should be noted that many other ranking schemes can be utilized. It should also be noted that embodiments of the invention are not limited to tracking only the aforementioned local attributes 321 and global threat attributes 322. Due to the ever-changing nature of risk, risk can be continually assessed and prioritized, and additional or different attributes can be tracked and added as needed. The example in FIG. 3 also illustrates how local attributes 321 and global threat attributes 322 can be collected and tallied, and how they can have transforms A-O applied independently to them, according to one embodiment. The transforms of these attributes can output the relative risk associated with each independent attribute. The transforms can consider the severity of the behavior when assigning the relative risk associated with the attribute. As such, the transforms do not need to be identical, and each attribute may affect overall risk in a different manner.

For example, the number of connection attempts 354 attribute can represent a malware-compromised asset's attempt at reaching an external entity. Although this behavior contains associated risk, the magnitude of the risk may be linear with increased attempts and considered far less severe with frequency than that of an asset that has successfully connected to a server, and has received information and commands to execute, along with data to transmit, represented by the bytes in and bytes out attributes, with the severity of the risk increasing exponentially with the amount of information received and sent. Transforms B and C can use a different scale, such as one that is logarithmic in nature, when considering how to transform the bytes in/bytes out attribute risk and assign risk accordingly. Independent risks A-O and α-β can thus be calculated for every attribute, according to one embodiment, as follows:

Risk A—Asset Priority. The asset priority risk can be a number in the 1-5 range assigned by the user to an asset or group of assets, with 1 representing a high-priority asset, and 5, a low priority asset. The number assigned can be compared against a set of preselected ranges, and the risk associated with the ranges can then be assigned to the asset(s). As an example, when a user sets an asset to category priority 5, the risk assigned to the asset can be set to 10; priority 1 assets, conversely, could have an assigned risk of 100.

Risk B—Bytes In. This can provide a log distribution of infected assets based on the amount of data transferred from the server to the assets. The log scale can be centered on the asset whose data in is the median of the distribution. The contribution for the bytes in risk can be increased logarithmically as bytes in scores exceed the median. As an example, if the median Bytes In for infected assets inside a network is 100 Kb, and asset A initially had 90 Kb of Bytes In but now has 120 Kb of Bytes In, then asset A's risk has surpassed the median and is now of substantially higher risk to an organization.

Risk C—Bytes Out. This can provide a log distribution of infected assets based on the amount of data transferred to the server from the assets. The log scale can be centered on the asset whose data in is the median of the distribution. The contribution for the bytes out risk can be increased logarithmically as bytes out scores exceed the median. As an example, if the median Bytes Out for infected assets inside a network is 100 Kb, and asset A initially had 90 Kb of Bytes Out but now has 120 Kb of Bytes Out, then asset A's risk has surpassed the median and is now of substantially higher risk to an organization.

Risk D—Number of Threats on Asset. This can be a number calculated according to the total number of threats present on an asset. The presented threat counts can be compared with preselected ranges that have an attributed risk weight associated with them. As an example, if the threat count presented is 3 or more, the highest attributed risk weight of 100 can be assigned as the number of threats on that particular asset.

Risk E—Connection Attempts. This can provide a log distribution of infected assets based on the number of connections to the server from the assets. The log scale can be centered on the asset whose data in is the median of the distribution. The contribution for the connection attempts risk can be increased logarithmically as connection attempt scores exceed the median. As an example, if the median Connection Attempts for infected assets inside a network is 100, and asset A initially had 90 Connection Attempts but now has 120 Connection Attempts, then asset A's risk has surpassed the median and is now of substantially higher risk to an organization.

Risk F—Success of Connection Attempts. This can be a number calculated according to the success rate of the total connection attempts made by an asset related to malicious network events. A connection attempt may be defined as successful upon the delivery or receipt of data from a malicious network event. The presented success rate can be compared with preselected ranges that have an attributed risk weight associated with them. As an example, if the success rate is greater than 80%, the highest attributed, risk weight of 100 can be assigned as the number of successful connection attempts.

Risk G—Geo-Location. The geo-location can be a number in the 1-5 range assigned by the user to specific geographic locations for connection attempts, with 1 representing a high-priority geo-location, and 5, a low-priority geo-location. The number assigned can be compared against a set of preselected ranges, and the risk associated with the ranges can be assigned to the asset(s). As an example, when a user sets a geo-location to priority 5, the risk assigned to the asset can be set to 10; priority 1 geo-locations conversely, could have an assigned risk of 100.

Risk H—Network Type. The network type can be a number in the 1-5 range assigned by the user to specific network types, with 1 representing high-priority network types, and 5 representing low-priority network types. The number assigned can be compared against a set of preselected ranges, and the risk associated with the ranges can be assigned to the asset(s). As an example, when a user sets a network type to priority 5, the risk assigned to the asset can be set to 10; a priority 1 network type conversely, could have an assigned risk of 100.

Risk I—Domain State. The domain state can be a number in the 1-5 range assigned by the user to specific domain states, with 1 representing the high-priority domain state, and 5, a low-priority domain states. The number assigned can be compared against a set of preselected ranges, and the risk associated with the ranges can be assigned to the asset(s). As an example, when a user sets a domain state to priority 5, the risk assigned to the asset can be set to 10; a priority 1 domain state conversely, could have an assigned risk of 100.

Risk J—Domain Type. The domain type can be a number in the 1-5 range assigned by the user to specific domain types, with 1 representing a high-priority domain type, and 5, a low-priority domain type. The number assigned can be compared against a set of preselected ranges, and the risk associated with the ranges can be assigned to the asset(s). As an example, when a user sets a domain type to priority 5, the risk assigned to the asset can be set to 10; a priority 1 domain type conversely, could have an assigned risk of 100.

Risk K—Malicious Files. This can be a number calculated according to the total number of Malicious Files delivered to an asset. The presented Malicious File counts can be compared with preselected ranges that have an attributed risk weight associated with them. As an example, if the Malicious File count presented is 3 or more, the highest attributed risk weight of 100 can be assigned as the number of Malicious. Files delivered to a particular asset.

Risk L—Payload. The payload type can be a number in the 1-5 range assigned by the user to specific payloads, with 1 representing the high-priority payload type, and 5, a low-priority payload type. The number assigned can be compared against a set of preselected ranges, and the risk, associated with the ranges can be assigned to the asset(s). As an example, when a user sets a payload type to priority 5, the risk assigned to the asset can be set to 10; a priority 1 payload type conversely, could have an assigned risk of 100.

Risk M—Marked Data. The marked data can be a number in the 1-5 range assigned by the user to specific marked data types, with 1 representing a high-priority marked data type, and 5, a low-priority marked data type. The number assigned can be compared against a set of preselected ranges, and the risk associated with the ranges can be assigned to the asset(s). As an example, when a user sets a marked data type to priority 5, the risk assigned to the asset can be set to 10; a priority 1 marked data type conversely, could have an assigned risk of 100.

Risk N—Vulnerabilities. A vulnerability can be a number in the 1-5 range assigned by the user to specific vulnerability types, with 1 representing a high-priority vulnerability, and 5 a low-priority vulnerability. The number assigned can be compared against a set of preselected ranges, and the risk associated with the ranges can be assigned to the asset(s). As an example, when a user sets a vulnerability type to priority 5, the risk assigned to the asset can be set to 10; a priority 1 vulnerability type conversely, could have an assigned risk of 10.

Risk α—AV Coverage. AV coverage risk can be an average of AV coverage for all threats on the asset. This can be only counted for the AV engine that a user has selected as their AV, a configurable option within one embodiment of the invention. The presented AV coverage number can correspond to preselected ranges that have an attributed risk weight associated with them. As an example, if an AV vendor's coverage is displayed as 90%, for the variants related to the threat, the lowest risk weight can be assigned to AV coverage's risk; conversely, an AV vendor displaying 0% for the same variants can have the highest risk weight assigned.

Risk β—Severity. A risk score can be calculated and set by the severity of a threat on an asset based on knowledge of previously observed exploits and threats. This risk score can be delivered directly to the product, and can range from 0-100. As an example, if the Severity is 80 for a threat on an asset, then that asset has a lower risk than an asset with a threat Severity of 90.

It should be noted that the above risks A-O and α-β are only example risks and ranges, and that other risks and ranges and/or combinations of the risks and ranges above can be used instead of or in addition to the risks and ranges above.

In one embodiment, risks A-O and α-β can be aggregated into algorithm 330. The algorithm 330 can calculate composite risk 331, which can, in one embodiment, be a number derived through the weighted aggregation of risks A-O and α and β, as follows:

### Algorithm: Part Weighting

The overall asset risk factor can be made up of weighted factors, according to the following formula (with W representing Weight in the formula):

AV Coverage*W1|Normal|ZZMPTAG∥Normal|ZZMPTAG∥Normal|ZZMPTAG∥Normal|ZZMPTAG|

Severity Score*W2|Normal|ZZMPTAG∥Normal|ZZMPTAG∥Normal|ZZMPTAG∥Normal|ZZMPTAG|

Threat Count Score*W3|Normal|ZZMPTAG∥Normal|ZZMPTAG∥Normal|ZZMPTAG∥Normal|ZZMPTAG|

Priority Score*W4|Normal|ZZMPTAG∥Normal|ZZMPTAG∥Normal|ZZMPTAG∥Normal|ZZMPTAG|

Connection Attempt Score*W5|Normal|ZZMPTAG∥Normal|ZZMPTAG∥Normal|ZZMPTAG∥Normal|ZZMPTAG|

Bytes Out Score*W6|Normal|ZZMPTAG∥Normal|ZZMPTAG∥Normal|ZZMPTAG∥Normal|ZZMPTAG|

Bytes In Score*W7|Normal|ZZMPTAG∥Normal|ZZMPTAG∥Normal|ZZMPTAG∥Normal|ZZMPTAG|

Success of Connection Attempts Score*W8|Normal|ZZMPTAG∥Normal|ZZMPTAG∥Normal|ZZMPTAG∥Normal|ZZMPTAG|

Geo-location Score*W9|Normal|ZZMPTAG∥Normal|ZZMPTAG∥Normal|ZZMPTAG∥Normal|ZZMPTAG|

Network Type Score*W10|Normal|ZZMPTAG∥Normal|ZZMPTAG∥Normal|ZZMPTAG∥Normal|ZZMPTAG|

Domain State Score*W11|Normal|ZZMPTAG∥Normal|ZZMPTAG∥Normal|ZZMPTAG∥Normal|ZZMPTAG|

Domain Type Score*W12|Normal|ZZMPTAG∥Normal|ZZMPTAG∥Normal|ZZMPTAG∥Normal|ZZMPTAG|

Malicious Files Score*W13|Normal|ZZMPTAG∥Normal|ZZMPTAG∥Normal|ZZMPTAG∥Normal|ZZMPTAG|

Payload Score*W14|Normal|ZZMPTAG∥Normal|ZZMPTAG∥Normal|ZZMPTAG∥Normal|ZZMPTAG|

Marked Data Score*W15|Normal|ZZMPTAG∥Normal|ZZMPTAG∥Normal|ZZMPTAG∥Normal|ZZMPTAG|

Vulnerabilities Score*W16|Normal|ZZMPTAG∥Normal∥ZZMPTAG∥Normal|ZZMPTAG∥Normal|ZZMPTAG

### Algorithm: Aggregate Score Calculation

The final risk score calculation can be an average of the weighted independent risks A-O and α-β. As an example, a set of assets will have different Composite Risk scores based on the aggregation and calculations of each asset's individual risks A-O and α-β. Therefore, an asset with low individual risks A-O and α-β will have a lower Composite Risk score than an asset with high, individual risks A-O and α-β. However, some individual risk scores may contribute more than other individual risk scores to an asset's Composite Risk score.

The output can be the asset risk factor score. This number can represent the relative risk of an asset in reference to other assets on the network, a relative distribution 332, and as such does not represent a comparison against an absolute value of risk, according to one embodiment. It should be noted that many other algorithms can be use to compute the asset risk factor score. Algorithm 330 in FIG. 3 is used to input and apply weights to each individual risk score calculated for an asset. The Algorithm outputs a Composite Risk 332 in. FIG. 3 for every asset being analyzed and performs a Relative Distribution 331 in FIG. 3 of the risk of the infected assets within a network.

Table 340 in FIG. 3 illustrates an example output of the weighted algorithm output from 331, according to one embodiment. The scale in this example is a number from 0-10, with one decimal place supported.

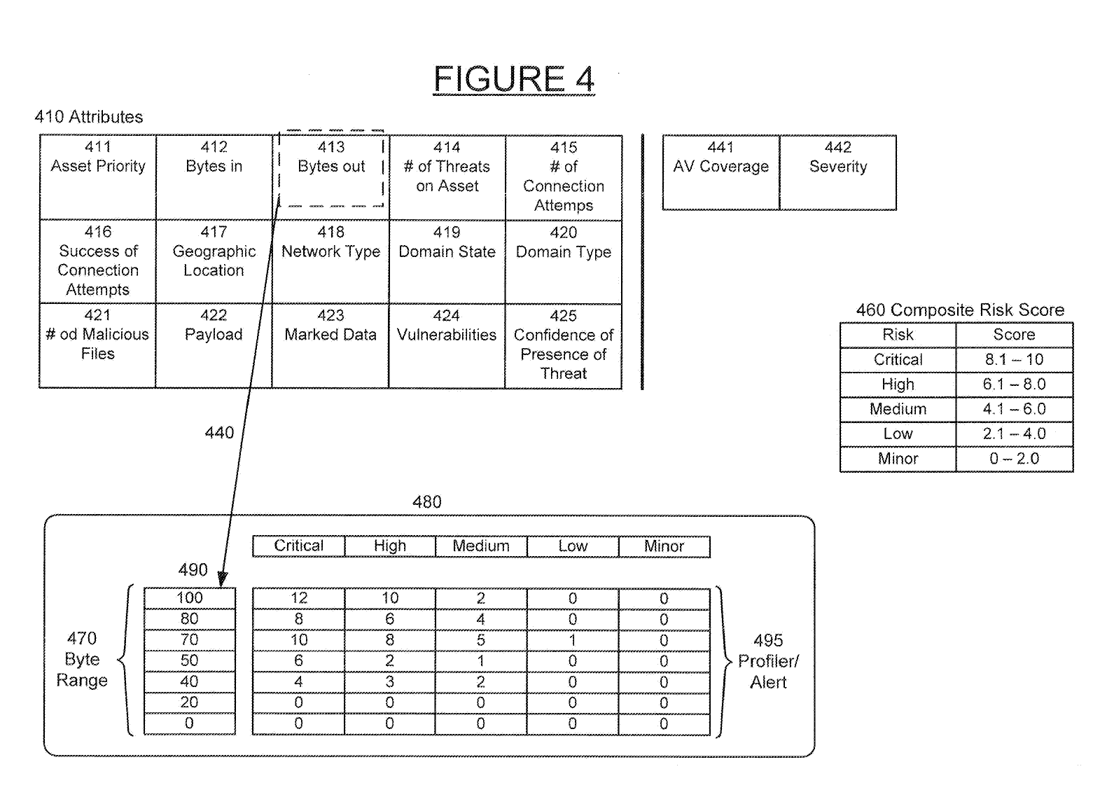

FIG. 4 illustrates example 480 of a Profiler 495, according to one embodiment. Composite risk scores ascertained via Algorithm 330 in FIG. 3 may be correlated against specific Attributes 410 to prioritize remediation efforts, according to a company's internal policies and/or highest level of concern, according to another embodiment.

FIG. 4 illustrates example 480 where attribute 413, which corresponds to the bytes out 352 attribute (of FIG. 3), is isolated and expanded to encompass a range (e.g., in this case 0-100 KB). The byte range 470 can then be plotted on the Y-axis 470 of a cross-tabular chart. The composite risk score 460 can be plotted on the X-axis of the same chart. The cross-tabular comparison between the composite risk score 460 and the bytes out 352 attribute can display the total number of assets in every range (e.g., Critical, High, Medium, Low, Minor) found to have the bytes out 352 attribute in the 0-100 KB range. The cross-tabular result of this comparison can represent profiler 495's output. When examining profiler 495's output, a user can have the ability to select individual numbers displayed on the chart. The individual numbers can represent hyperlinks to tables where details about the assets and evidence, in the form of forensics and attributes pertaining to their level of infected state, can be presented. Users can thus prioritize remediation efforts by concentrating on areas of the chart where the highest concentration of relative risk, based on a user's perspective, is displayed. For example 480 in FIG. 4, dashed square 490 can represent the highest concentration of numbers for this environment. All numbers (e.g., assets) within this square may be prioritized for remediation efforts.

Example 480 in FIG. 4 can represent one embodiment of Profiler 495's capacity. Any attribute may be expanded and compared against composite risk score 460. Companies may prioritize remediating high-risk assets according to the attribute that represents the greatest risk to their organization, according to their business model. For example, a financial institution may prioritize remediating high-risk assets with alarming levels of bytes out 352 attributes, representing potential loss of highly sensitive data (e.g., bank records, credit card numbers, transactions, etc.). However, the same institution may experience a targeted attack that may shift remediation efforts toward assets found to have a high number of connection attempt 354 attributes, representing a widespread number of malware-infected assets that are in the process of attempting CnC connections. As the attack wanes, AV coverage 380 may become critical in ascertaining the company's protection against future attacks. In all, profiler 495's correlation capacities are not confined by composite risk score 460. As other attributes are added to composite risk score 460, profiler 495 can add them to the available cross-tab items used for data correlation.

The profiler 495 illustration in FIG. 4 can also used as a means to alert corporate asset administrators of high-risk behaviors associated with important assets, according to one embodiment. Alerts can be prioritized according to the composite risk score category. For example, administrators may choose to be alerted when assets have an associated risk 460 greater than medium, where the number of connection attempts 415 exceeds a pre-defined threshold. Administrators can thus filter high-priority alerts from lesser threats.

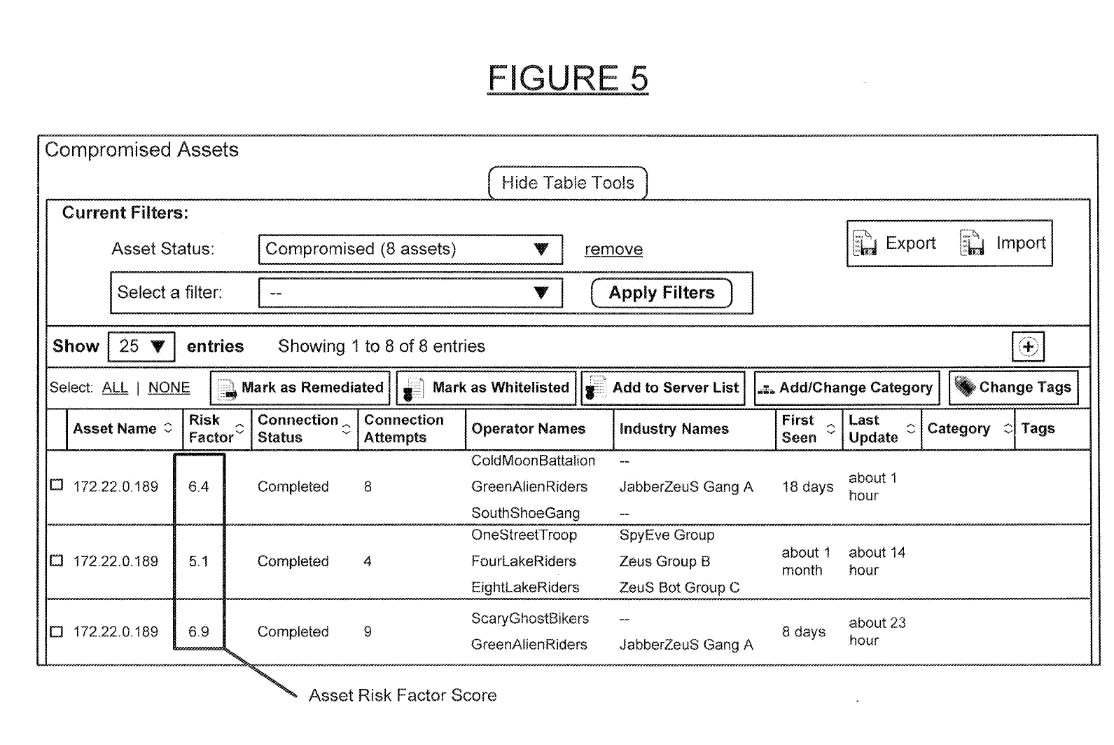

FIG. 5 illustrates information about particular assets, according to one embodiment of the invention. As explained above, once an asset has been identified as compromised, remediation and/or other efforts related to the compromised assets must be prioritized. A system to prioritize such efforts can be provided. As shown in FIG. 5, in one embodiment, the highlighted rectangle in the figure encircles the asset risk factor score. An asset risk factor score can be derived based upon attributes of an asset's communication with an external entity, as discussed previously. As an example, the asset risk factor can be a number ranging from 0 to 10, where 0 is the least risky and 10 is the most risky. Prioritization of remediation efforts can thus parallel the asset risk factor score: higher asset risk factor scores can equal higher prioritization of remediation efforts, and vice-versa.

FIG. 5, serving as a representation of both malicious network event activity and risk attributes, can also include, but is not limited to, information about: the asset name, the connection attempts, the operator names, the industry names, when first seen, the last update, the category, or tags, or any combination thereof. Embodiments of these are described in more detail below. It should be noted that other embodiments are also possible.

Asset Name. Either the asset's network name or its IP address.|Normal|ZZMPTAG∥Normal|ZZMPTAG∥Normal|ZZMPTAG∥Normal|ZZMPTAG|

Connection Attempts. Total amount of times an asset attempted to communicate with an external entity, regardless of success.|Normal|ZZMPTAG∥Normal|ZZMPTAG∥Normal|ZZMPTAG∥Normal|ZZMPTAG|

Operator Names. Arbitrary name assigned to an identified threat.|Normal|ZZMPTAG∥Normal|ZZMPTAG∥Normal|ZZMPTAG∥Normal|ZZMPTAG|

Industry Names. Name assigned by industry threat analysis vendors to the identified threat.|Normal|ZZMPTAG∥Normal|ZZMPTAG∥Normal|ZZMPTAG∥Normal|ZZMPTAG|

First Seen. Time (e.g., in days) when the asset was first seen to communicate with an external entity.|Normal|ZZMPTAG∥Normal|ZZMPTAG∥Normal|ZZMPTAG∥Normal|ZZMPTAG|

Last Update Time (e.g., in days) when the asset was last seen to communicate with the external entity.|Normal|ZZMPTAG∥Normal|ZZMPTAG∥Normal|ZZMPTAG∥Normal|ZZMPTAG|

Category User defined priority assigned to the asset.|Normal|ZZMPTAG∥Normal|ZZMPTAG∥Normal|ZZMPTAG∥Normal|ZZMPTAG|

Tags Subdivisions of the categories/priorities used to further segregate assets in a network.|Normal|ZZMPTAG∥Normal|ZZMPTAG∥Normal|ZZMPTAG∥Normal|ZZMPTAG|

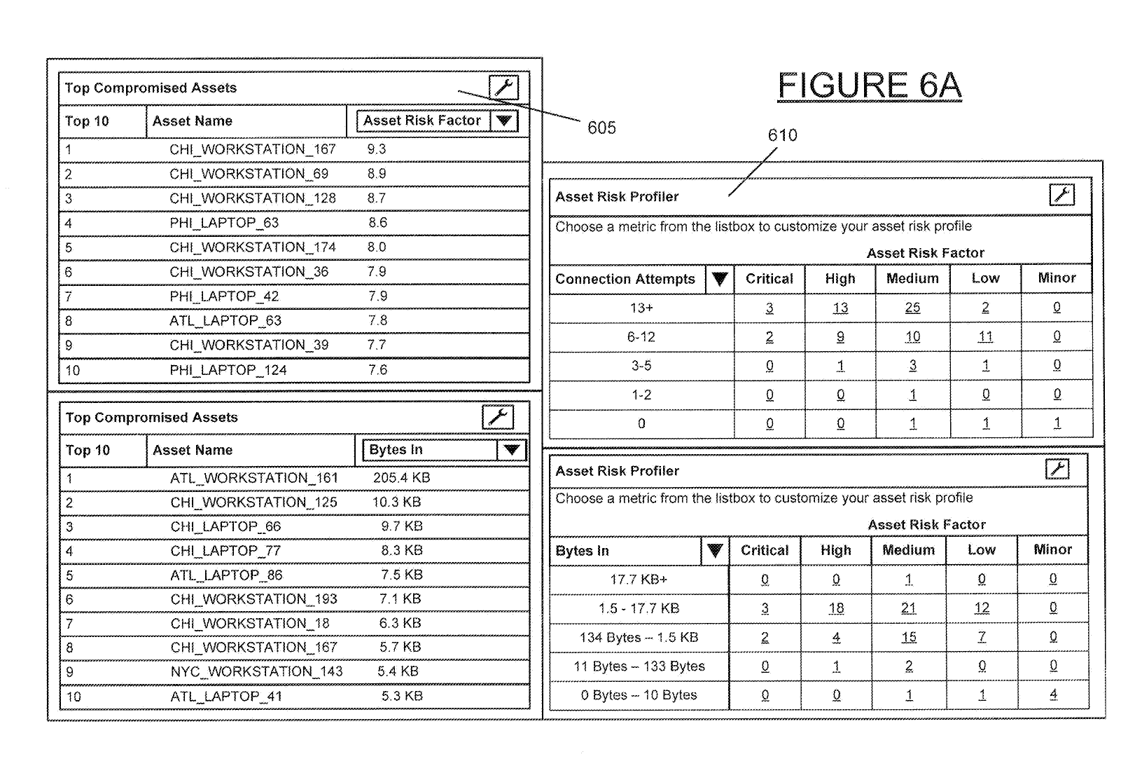

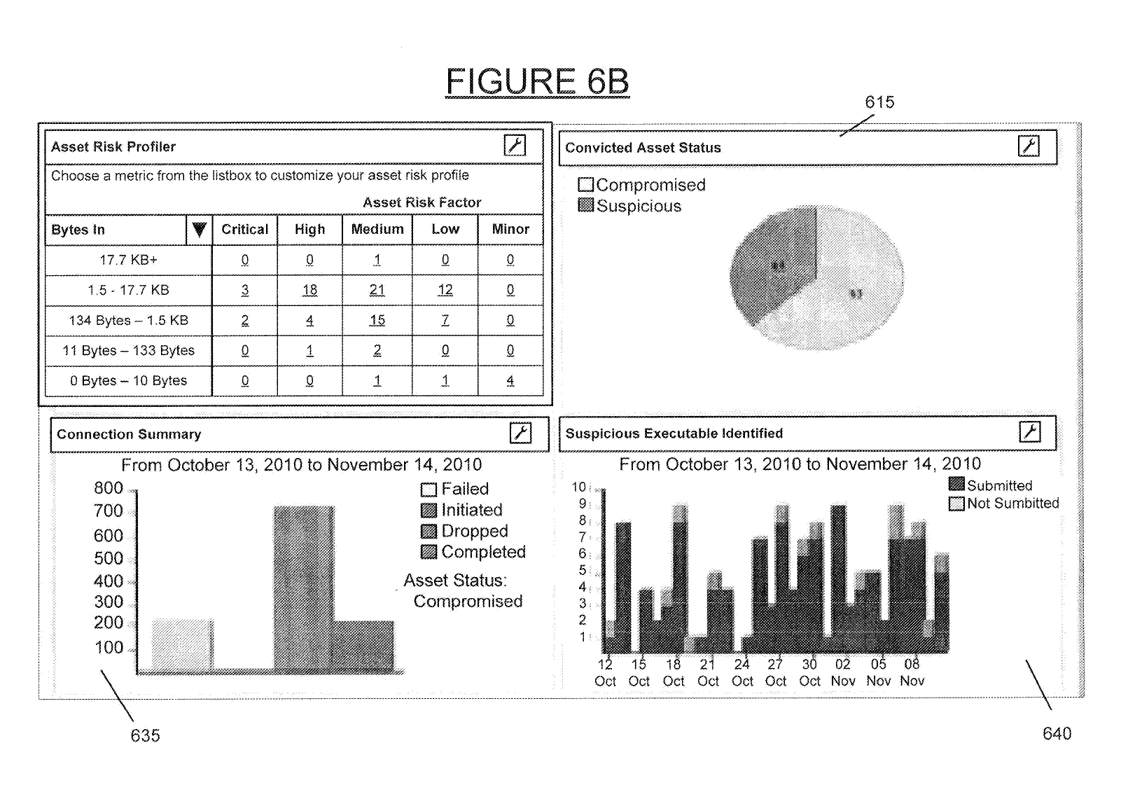

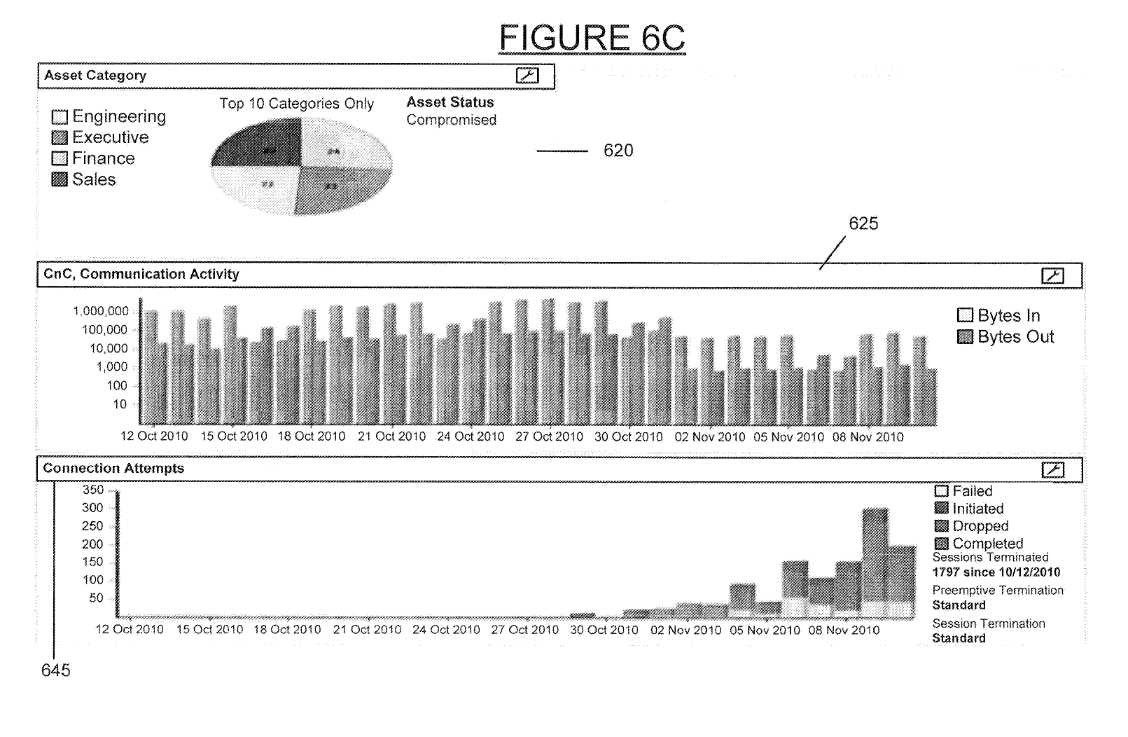

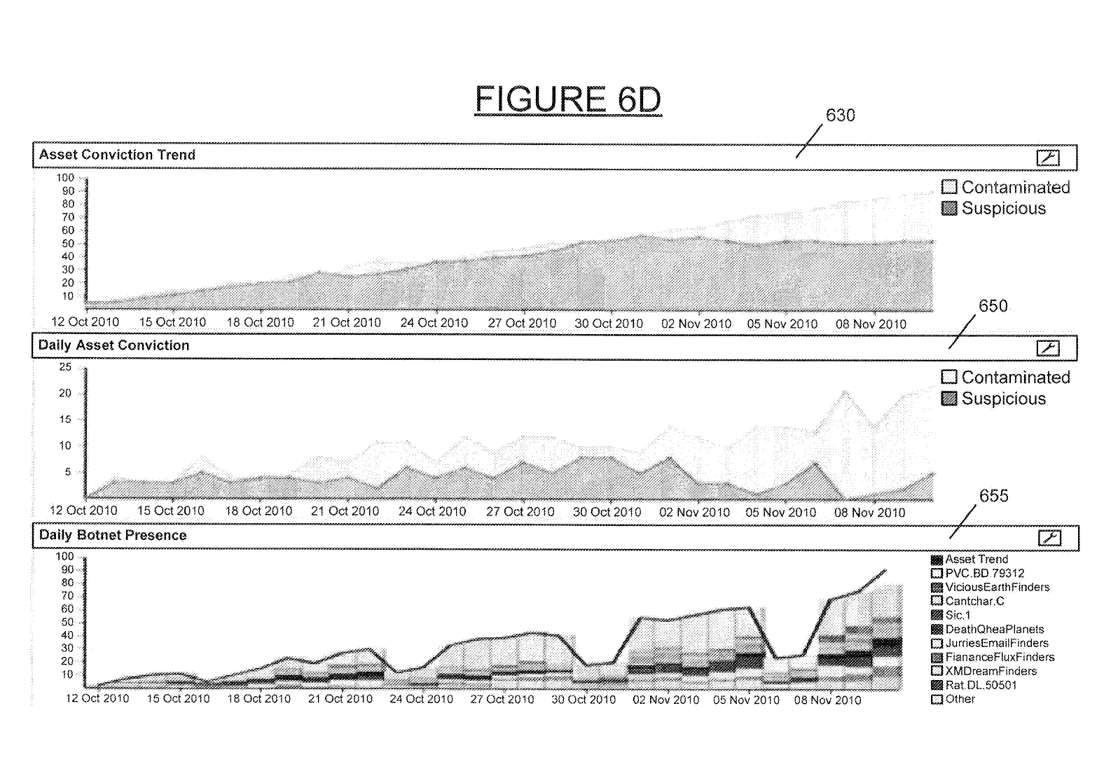

FIGS. 6A-6D illustrate a screen shot that shows information about assets within a network, according to one embodiment. As described above, a method can be provided to monitor and examine network traffic, looking for “interesting” network traffic that can indicate that a computer asset is behaving out-of-the-norm, exhibiting behavior that is associated with the presence of some type of threat on the computer asset. If a computer asset becomes infected with malware and communicates with an external network, this communication can be seen as a malicious network event and can be monitored closely. A series of malicious network events performed by the infected computer asset can cause the method to indicate that the computer asset has been compromised, as shown in the screen shot in FIGS. 6A-6D. The evidence can be reviewed and attributes which enable risk assessment can be categorized, prioritized, and admonished.

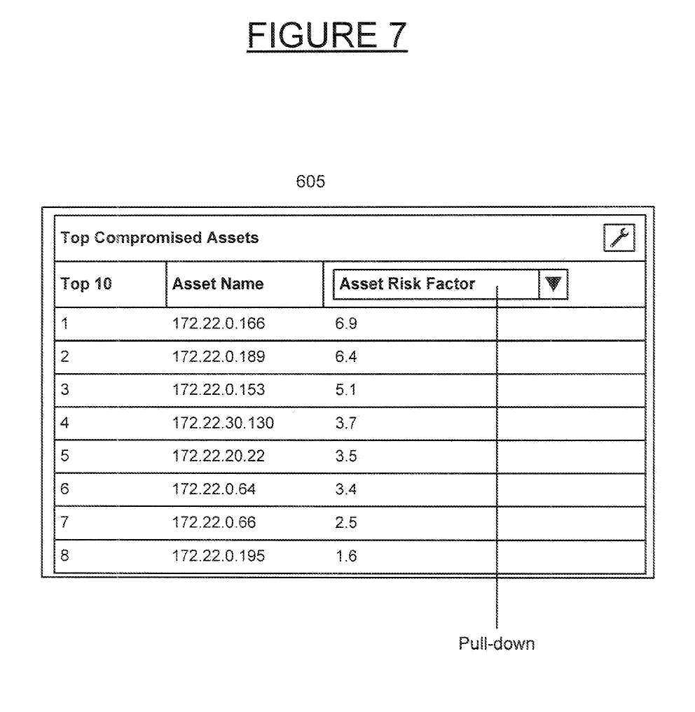

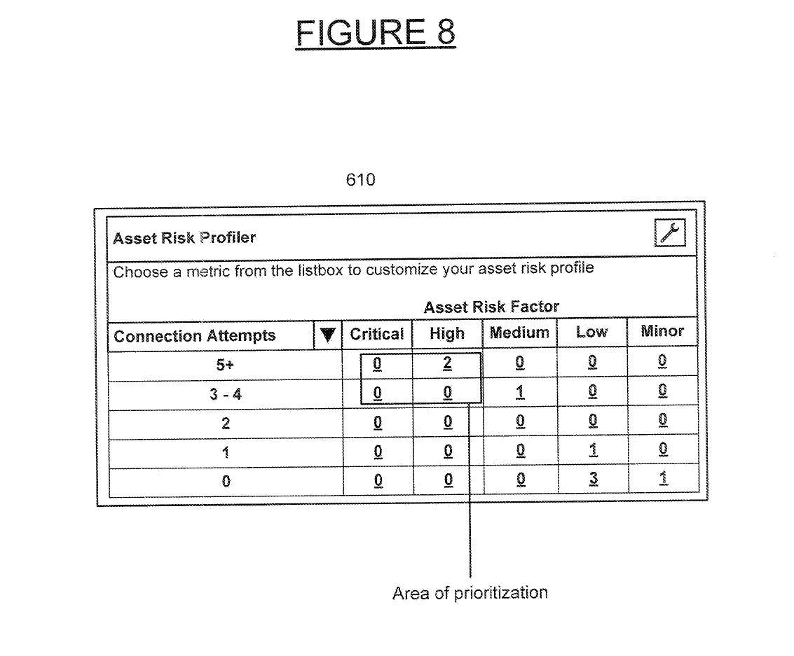

FIGS. 6A-6D can include, but is not limited to: at least one top compromised assets list 605 and/or at least one an asset risk profiler 610, both of which can provide different representations of risk. These are described in more detail in FIGS. 7 and 8 below.

The screen shot of FIGS. 6A-6D can also include various charts, including, but not limited to: convicted asset status 615, asset category 620, connection summary 635, suspicious executables identified 640, communication activity 625, connection attempts 645, asset conviction trend 630, daily asset conviction 650, or daily botnet presence 655, or any combination thereof. Embodiments of this information are described as follows:

615 Convicted Asset Status. A pie chart depicting the total number of assets that have engaged in communication to unknown external entities, displayed as suspicious (e.g., possible communication) or convicted (e.g., definite communication).|Normal|ZZMPTAG∥Normal|ZZMPTAG∥Normal|ZZMPTAG∥Normal|ZZMPTA G|

620 Asset Category. A pie chart depicting the total number of assets that have engaged in communication to unknown external entities, displayed according to category, filtered by suspicious (e.g., possible communication) or convicted (e.g., definite communication).|Normal|ZZMPTAG∥Normal|ZZMPTAG∥Normal|ZZMPTAG∥Normal|ZZMPTA G|

635 Connection Summary. A bar graph depicting the total number of connections attempted by internal assets to external unknown entities, whether initiated, successful, failed or dropped.|Normal|ZZMPTAG∥Normal|ZZMPTAG∥Normal|ZZMPTAG∥Normal|ZZMPTAG|

640 Suspicious Executables Identified. A bar graph depicting the total number of unidentified executable programs downloaded in the network, filtered by submitted (e.g., by users) or un-submitted status.|Normal|ZZMPTAG∥Normal|ZZMPTAG∥Normal|ZZMPTAG∥Normal|ZZMPTAG|

625 Communication Activity. A bar graph depicting asset communication to known external threats, filtered by data (e.g., bytes) into and out of, the network.|Normal|ZZMPTAG∥Normal|ZZMPTAG∥Normal|ZZMPTAG∥Normal|ZZMPTAG|

645 Connection Attempts. A bar graph depicting information contained in 635 connection summary, according to specific dates.|Normal|ZZMPTAG∥Normal|ZZMPTAG∥Normal|ZZMPTAG∥Normal|ZZMPTAG|

630 Asset Conviction Trend. A stacked marked line chart depicting information contained in 615 convicted asset status, according to a specific timeline.|Normal|ZZMPTAG∥Normal|ZZMPTAG∥Normal|ZZMPTAG∥Normal|ZZMPTAG|

650 Daily Asset Conviction. A stacked marked line chart depicting information contained in 615 convicted asset status, according to a single day.|Normal|ZZMPTAG∥Normal∥ZZPTAG∥Normal|ZZMPTAG∥Normal|ZZMPTAG|

655 Daily Botnet Presence. A stacked marked line chart depicting information pertaining to specific identified threats, with a user-defined date range.|Normal|ZZMPTAG∥Normal|ZZMPTAG∥Normal|ZZMPTAG∥Normal|ZZMPTAG|

FIG. 7 illustrates a top compromised assets list 605, according to one embodiment. To facilitate sorting and displaying what could be potentially thousands of assets, a certain number (e.g., 10) of prioritized assets can be presented, as defined by their asset risk factor score. Those of ordinary skill in the art will see that any number of top compromised assets can be designated and shown. Along with the asset risk factor, the top compromised asset list 605 can also present and/or rank other attributes such as, but not limited to, bytes out, bytes in, connection attempts, related AV coverage, and machine category/priority (as well as additional or different attributes such as, but not limited to: success of connection attempts, geo-location, network type, domain state, domain type, number of malicious files, payload, marked data, vulnerabilities, and threat confidence), as illustrated in the pull-down box shown within the highlight rectangle in the graphic.

FIG. 8 illustrates an asset risk profiler 610, according to one embodiment. As noted previously, the asset risk factor can be a composite of different risks associated with different attributes. Threat response teams may prioritize one type of attribute over another. As such, threat response teams may prefer viewing that one particular attribute's contribution to the whole asset risk factor. To facilitate viewing, or separating, this information from the total asset risk factor, an asset risk profiler 610 can be provided, which can be a table. The X-axis of the table can be the asset risk factor category, which for example, can be determined by the asset risk factor score. For example, an asset risk factor score over 8.1 can be categorized as critical. The Y-axis of the table can be a user-selectable attribute. In the example of FIG. 8, the user-selected attribute can be connection attempts. The table can thus present the number of assets that have participated in that type of activity (e.g., attribute) and the magnitude of that activity (e.g., per the Y-axis scale). In one embodiment, a threat remediation team can prioritize certain attributes and certain assets. For example, as shown in the highlighted rectangle within FIG. 8, a threat remediation team can prioritize the attribute of connection attempts and assets located in the Critical/High categories (e.g., X-axis), with over 3 connection attempts (e.g., Y-axis). The “hand” symbol within the graphic points to the assets in question.

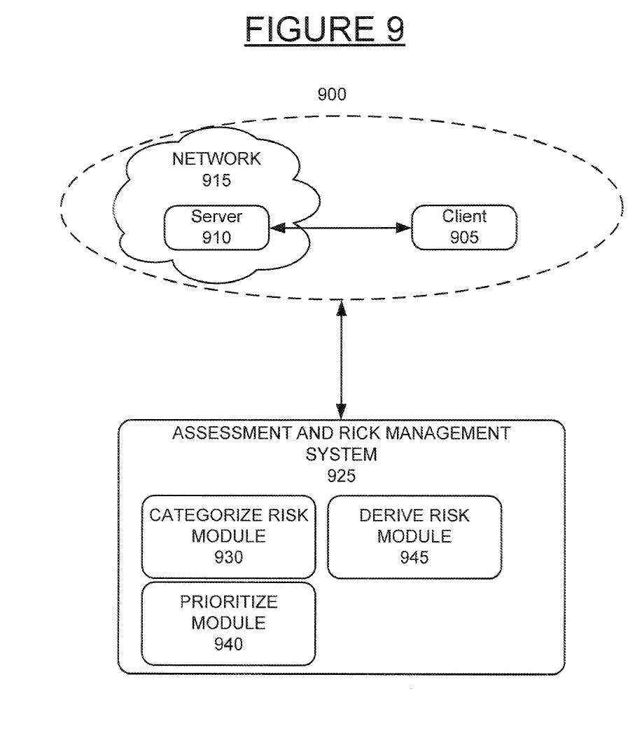

FIG. 9 illustrates a system for assessing and managing risk associated with at least one compromised network, according to one embodiment. FIG. 9 shows a client computer 905 connected or attempting to connect to an external sever computer 910 over network 915. An assessment and risk management system 925 can be applied to the communications between client computer 905, server computer 910, or through network 915, or any combination thereof, which, in one embodiment, can include a prioritize asset risk module 940, a categorize risk module 930, or a derive risk module 945, or any combination thereof. In one embodiment, the assessment and risk management system 925 can receive information about network assets (e.g., including compromised network assets) from other applications. The prioritize asset risk module 940 can be used to prioritize remediation on the asset. For example, the asset priority attribute 350 in FIG. 3 can be utilized to prioritize the network asset's relative importance and the prioritize asset risk module 940 can use this information to prioritize remediation on the asset. The categorize risk module 930 can be utilized to categorize information received about network assets. For example, some or all of the local attributes 321 and global attributes 322 in FIG. 3 can be utilized to categorize risk. In one embodiment, sensors can also be utilized to collect data that can be used to assess and categorize risk. For example, referring to FIGS. 2A and 2B, sensors can be placed in various parts of a network 210 in order to collect data. For example, one or more sensors can be placed on various locations within the path of network event 220 to collect the data utilized in some or all of the local attributes. (It should be noted that in FIG. 2B, the path of network event 220 can go around firewall 212.) This data can be collected by monitoring host performing communications as shown in 900 and/or by any other manner. The derive risk module 945 can be utilized to give a score to the risk of each network asset. For example, an asset risk factor score can be calculated, as described above.

While various embodiments of the present invention have been described above, it should be understood that they have been presented by way of example, and not limitation. It will be apparent to persons skilled in the relevant art(s) that various changes in the form and detail can be made therein without departing from the spirit and scope of the present invention. Thus, the invention should not be limited by any of the above-described exemplary embodiments.

In addition, it should be understood that the figures described above, which highlight the functionality and advantages of the present invention, are presented for example purposes only. The architecture of the present invention is sufficiently flexible and configurable, such that it may be utilized in ways other than that shown in the figures.

Further, the purpose of the Abstract of the Disclosure is to enable the U.S. Patent and Trademark. Office and the public generally, and especially the scientists, engineers and practitioners in the art who are not familiar with patent or legal terms or phraseology, to determine quickly from cursory inspection the nature and essence of the technical disclosure of the application. The Abstract of the Disclosure is not intended to be limiting as to the scope of the present invention in any way.

It, should also be noted that the terms “a”, “an”, “the”, “said”, etc. signify “at least one” or “the at least one” in the specification, claims and drawings. In addition, the term “comprising” signifies “including, but not limited to”.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method of managing risk associated with at least one compromised network asset, comprising:
performing processing associated with receiving evidence regarding the at least one compromised network asset, the evidence stored in at least one electronic database;
performing processing associated with assessing at least one risk associated with the at least one compromised network asset by the at least one assessment and risk management system, wherein the assessing comprises a weighting process that provides a weight for each attribute used to assess the at least one risk; and/or
performing processing associated with prioritizing at least two compromised network assets in order to determine how to respond to the at least one risk, the prioritizing performed by the at least one assessment and risk management system.

2. The method of claim 1, wherein the at least two compromised network assets are prioritized by assessing at least one individual attribute risk related to each compromised network asset.

3. The method of claim 1, wherein the at least two compromised network assets are prioritized by assessing individual attribute risks to aggregate and transform into at least one overall risk.

4. The method of claim 2, wherein the at least one attribute is at least one global attribute or at least one local attribute.

5. The method of claim 3, wherein the at least one local attribute comprises: at least one connection attempt attribute indicative of the frequency of connection attempts to at least one malware remote operator; at least one bytes in attribute indicative of instruction sets and/or repurposing of malware on the at least one compromised network asset; at least one bytes out attribute indicative of exfiltrated data; at least one number of threats present on at least one compromised network asset indicative of level of compromise of at least one compromised network asset; at least one asset category priority indicative of relative importance of the at least one compromised network asset; at least one successful connection attempt indicative of data exiting to or entering from one mal ware remote operator; at least one geographic location indicative of communication with an untrusted geography on at least one compromised network asset; at least one network type indicative of communication with an untrusted network on at least one compromised network asset; at least on DNS query or connection attempt to a domain that is either active or sinkholed on at least one compromised network asset; at least one malicious file delivered to at least one compromised network asset; at least one encrypted or obfuscated payload during a connection attempt from at least one compromised network asset; at least one file identified with privacy markings observed during a connection attempt from at least one compromised network asset; at least one vulnerability identified on at least one compromised network asset; at least one heightened level of confidence of the presence of a threat on at least one compromised network asset; or any combination thereof.

6. The method of claim 3, wherein the at least one global attribute comprises: at least one related AV coverage indicative of coverage of at least one threat by at least one existing AV solution; and/or at least one threat severity attribute indicative of at least one assessment of the risk of the threat globally.

7. The method of claim 2, wherein the risk of the at least one attribute is assessed by transforming the at least one attribute by converting raw attribute data into individual attribute risk.

8. The method of claim 3, wherein weight is assigned to the individual attribute risk according to the at least one attribute's perceived risk level.

9. The method of claim 3, wherein individual attribute risks are aggregated and transformed into at least one overall risk.

10. The method of claim 1, wherein the individual attribute or overall risk is prioritized via at least one one-dimensional list menu with at least one attribute sorter and/or filter.

11. The method of claim 1, wherein the at least one overall risk is correlated with any individual attribute risk and the result is displayed in at least one threat matrix, allowing at least one user to quickly identify at least one most important compromised network asset to at least one organization.

12. The method of claim 1, wherein at least one user can be alerted regarding the at least two prioritized compromised network assets by their associated individual attribute risk or by the overall risk via at least one alert used to trigger incident response efforts.

13. The method of claim 2, wherein the at least one user is able to quickly identify the most important compromised network assets to at least one organization based on the at least one user's perspective of which at least one individual attribute risk is the most important to the at least one organization.

14. The method of claim 3, wherein the at least one user is able to quickly identify the most important compromised network assets to at least one organization based on the at least one user's perspective of which the overall risk is the most important to at least one organization.

15. The method of claim 12, wherein the at least one alert is updated in real time as new evidence is collected.

16. The method of claim 2, wherein the at least one individual attribute risk is updated in real time as new evidence is collected.

17. The method of claim 3, wherein the overall risk is updated in real time as new evidence is collected.

18. A system of managing risk associated with at least one compromised network asset, comprising:
at least one processor, configured for:
performing processing associated with receiving evidence regarding the at least one compromised network asset, the evidence stored in at least one electronic database;
performing processing associated with assessing at least one risk associated with the at least one compromised network asset by the at least one assessment and risk management system, wherein the assessing comprises a weighting process that provides a weight for each attribute used to assess the at least one risk; and/or
performing processing associated with prioritizing at least two compromised network assets in order to determine how to respond to the at least one risk, the prioritizing performed by the at least one assessment and risk management system.

19. The system of claim 18, wherein the at least two compromised network assets are prioritized by assessing at least one individual attribute risk related to each compromised network asset.

20. The system of claim 18, wherein the at least two compromised network assets are prioritized by assessing individual attribute risks to aggregate and transform into at least one overall risk.

21. The system of claim 19, wherein the at least one attribute is at least one global attribute or at least one local attribute.

22. The system of claim 20, wherein the at least one local attribute comprises: at least one connection attempt attribute indicative of the frequency of connection attempts to at least one malware remote operator; at least one bytes in attribute indicative of instruction sets and/or repurposing of malware on the at least one compromised network asset; at least one bytes out attribute indicative of exfiltrated data; at least one number of threats present on at least one compromised network asset indicative of level of compromise of at least one compromised network asset; at least one asset category priority indicative of relative importance of the at least one compromised network asset; at least one successful connection attempt indicative of data exiting to or entering from one malware remote operator; at least one geographic location indicative of communication with an untrusted geography on at least one compromised network asset; at least one network type indicative of communication with an untrusted network on at least one compromised network asset; at least on DNS query or connection attempt to a domain that is either active or sinkholed on at least one compromised network asset; at least one malicious file delivered to at least one compromised network asset; at least one encrypted or obfuscated payload during a connection attempt from at least one compromised network asset; at least one file identified with privacy markings observed during a connection attempt from at least one compromised network asset; at least one vulnerability identified on at least one compromised network asset; at least one heightened level of confidence of the presence of a threat on at least one compromised network asset; or any combination thereof.

23. The system of claim 20, wherein the at least one global attribute comprises: at least one related AV coverage indicative of coverage of at least one threat by at least one existing AV solution; and/or at least one threat severity attribute indicative of at least one assessment of the risk of the threat globally.

24. The system of claim 20, wherein the risk of the at least one attribute is assessed by transforming the at least one attribute by converting raw attribute data into individual attribute risk.

25. The system of claim 20, wherein weight is assigned to the individual attribute risk according to the at least one attribute's perceived risk level.

26. The system of claim 20, wherein individual attribute risks are aggregated and transformed into at least one overall risk.

27. The system of claim 19, wherein the individual attribute or overall risk is prioritized via at least one one-dimensional list menu with at least one attribute sorter and/or filter.

28. The system of claim 18, wherein the at least one overall risk is correlated with any individual attribute risk and the result is displayed in at least one threat matrix, allowing at least one user to quickly identify at least one most important compromised network asset to at least one organization.

29. The system of claim 18, wherein at least one user can be alerted regarding the at least two prioritized compromised network assets by their associated individual attribute risk or by the overall risk via at least one alert used to trigger incident response efforts.

30. The system of claim 19, wherein the at least one user is able to quickly identify the most important compromised network assets to at least one organization based on the at least one user's perspective of which at least one individual attribute risk is the most important to the at least one organization.

31. The system of claim 20, wherein the at least one user is able to quickly identify the most important compromised network assets to at least one organization based on the at least one user's perspective of which the overall risk is the most important to at least one organization.

32. The system of claim 29, wherein the at least one alert is updated in real time as new evidence is collected.

33. The system of claim 19, wherein the at least one individual attribute risk is updated in real time as new evidence is collected.

34. The system of claim 20, wherein the overall risk is updated in real time as new evidence is collected.
